(19) United States
(12) Patent Application Publication
(10) Pub. No.: US 2006/0129573 A1
(43) Pub. Date: Jun. 15, 2006

(54) Method of editing indication for a portable electronic device

(75) Inventors: Shih-Chieh Chen, Taipei City (TW); Yueh-Chi Wang, Taipei City (TW); Chieh-Yu Chan, Taipei City (TW); Chien-Chung Chen, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/146,023

(22) Filed: Jun. 7, 2005

(30) Foreign Application Priority Data
Dec. 15, 2004 (TW) 093138996

(51) Int. Cl. G06F 7/00

(52) U.S. Cl. 707/100

(57) ABSTRACT

The present invention relates to a method of editing indication for a portable device, comprising: selecting an electronic file; determining whether an editing of the electronic file is performed; enabling the editing indication in the display screen of the portable device; and disable the editing indication when the editing is completed, wherein the portable device can be an MP3 player, PDA, or multimedia player; the electronic file can be a digital picture, music file, multimedia file, digital text file, electronically compressed file, or catalogue file.

### BACKGROUND OF THE INVENTION

1. FIELD OF THE INVENTION

The present invention relates to a method of editing indication for a portable electronic device.

2. DESCRIPTION OF THE RELATED ART

With the advance of the electronics technology, various kinds of portable electronic devices are currently available in miniaturized form, such as PDAS, multimedia players, etc. These kinds of portable electronic devices, due to their portability and the special functional services they provide or the powerful processing ability they serve, give the users great entertainment and convenience, thereby achieving the purpose to enjoy entertainment or perform document processing anytime.

As shown in FIG. 1, taking an MP3 (a coding format of music) player 10 as an example, the MP3 player 10 comprises the following components: a microprocessor 11, a memory 12, a decoder 13, and an audio amplifier 14. The memory 12 can be a volatility storage device such as flash memory or hard disc device to store MP3 files. The microprocessor 11 can read MP3 files stored in the memory 12 and output the MP3 files to the decoder 13 to execute a decoding process, and then the decoder 13 outputs the analog signal representing music or voice to the audio amplifier 14. Moreover, when the users execute an editing procedure such as moving or deleting the MP3 files, the procedure is controlled by the microprocessor 11. The audio amplifier 14 is adopted to connect with an output device, such as an earphone or loudspeaker, therefore the users can choose and execute a desired MP3 file and then hear music or voice from the output device.

When the capacity of the memory 12 of the MP3 player 10 increases, the users can store more MP3 files to the MP3 player. However, storing numerous MP3 files under the same catalogue will cause difficulty for the users not only in selecting or distinguishing MP3 files, but also make it troublesome to give the file names of the MP3 files. Therefore, users need to construct a tree structure to categorize MP3 files, allowing the MP3 files with similar characters to be grouped in a specific sub-dictionary. Later on, the users can rapidly select MP3 files they desire. Nevertheless, when the users execute editing procedures such as moving or copying to the MP3 files, the MP3 player 10 does not provide any indication or message about the editing status to the users, and this will cause the users difficulty in executing editing procedures.

### BRIEF SUMMARY OF THE INVENTION

To achieve these and other advantages, and in accordance with the purpose of the present invention as embodied and broadly described, there is provided a method of editing indication for a portable electronic device, comprising the following steps: (A) selecting electronic files; (B) determining whether or not to proceed editing to the electronic; if not proceeding, terminating execution of the method of editing indication; (C) enabling the editing indication of the display screen of portable device; and (D) when the editing is completed, disabling the editing indication. The portable device can be an MP3 player, PDA, or multimedia player. Electronic files can be digital photos, music files, multimedia files, word files, electronic compressed files, or catalogue files.

The accompanying drawings, which are incorporated in and constitute a part of this specification, illustrate several embodiments of the present invention and together with the description, serve to explain the principles of the present invention.

### BRIEF DESCRIPTION OF THE DRAWINGS

FIG. 1 is a functional block diagram of an MP3 player;

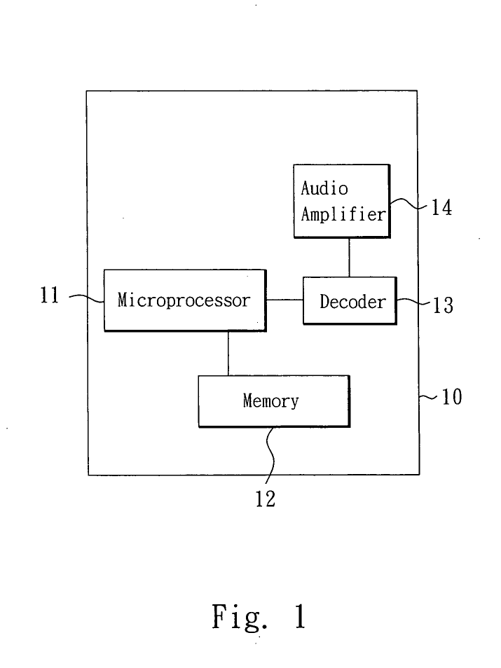

FIG. 2 is a flowchart of the method of editing indication according to the present invention; and

FIG. 3 is a chart of editing indication.

### DESCRIPTION OF THE EMBODIMENTS

Reference will now be made in detail to present embodiments of the present invention, examples of which are illustrated in the accompanying drawings. Wherever possible, the same reference numbers will be used throughout the drawings to refer to the same or like parts.

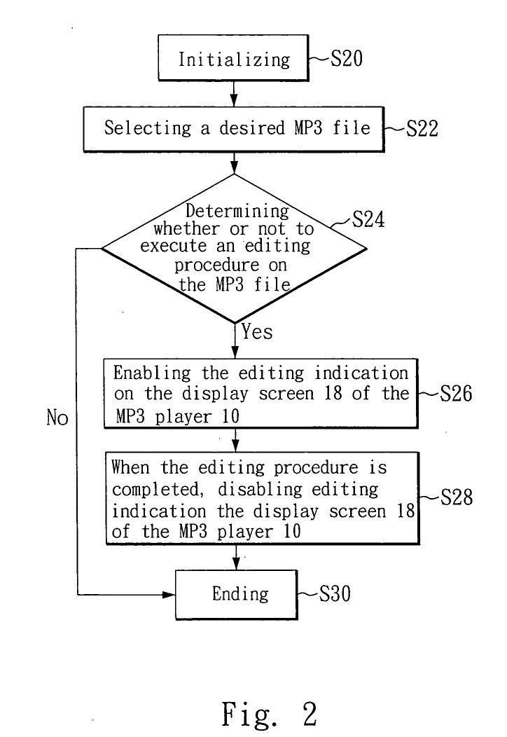

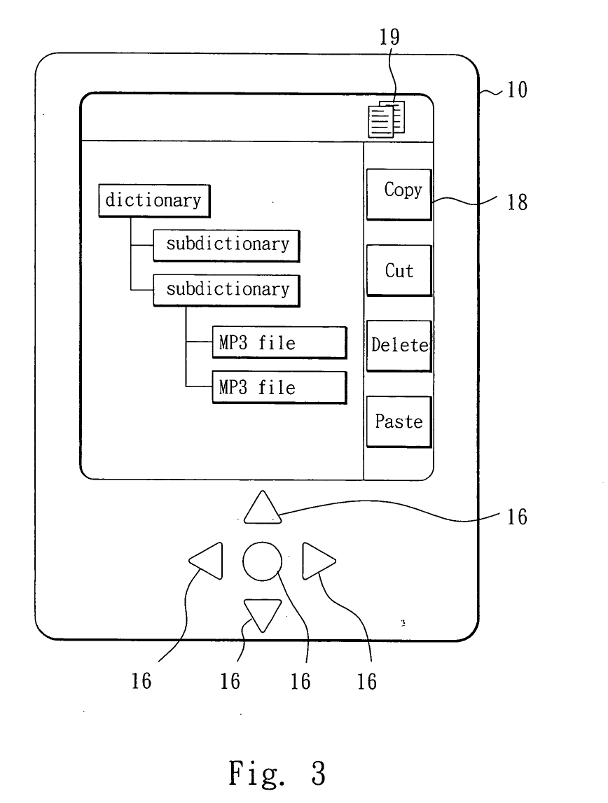

The method of editing indication of the portable electronic device according to the invention can be used to inform the users of a current editing status of the MP3 files. Due to the existence of various types of portable electrical devices, the MP3 player 10 and MP3 files are preferable exemplifications in the embodiment of the present invention, but the scope of the invention shall, however, not be restricted to this extent. As shown in the flowchart in FIG. 2, and referring to FIG. 3 for the chart of the MP3 player 10, the method of editing indication comprises the following steps:

Step S20 : Initializing.

Step S22 : Selecting a desired MP3 file. The users select one or several desired MP3 files to execute the editing procedure such as moving or copying. MP3 files can be replaced with any kind of electronic files, such as digital picture files, music files, multimedia files, word files, compressed files, or catalogue files. The extension name of the digital picture file is preferably one of GIF, JPG, TIF, PSD, EPS, Al, PNG, ICO, RAW, TGA and BMP. The extension name of the music file is preferably one of MP3, WMA, MC, OGG, RM, MIDI, PLP, M3U, PLS, WMX, CDA, AC3 and SACD. The extension name of the multimedia file is preferably one of MOV, RA, ASF, WMV, MPEG 1, MPEG 2, AVI, DAT and MPEG 4. The extension name of the document file is preferably one of DOC, TXT, PDF, PPT, HTML, EML and XLS. The extension name of the compressed file is preferably one of ZIP and RAR.

Step S24 : Determining whether or not to execute an editing procedure on the MP3 file. If the procedure is not executed, step S30 is executed.

Step S26 : Enabling the editing indication on a display screen 18 of the MP3 player 10. If the users want to execute the editing procedure to cut the MP3 file, as shown in FIG. 3, the users press control key 16 of the MP3 player 10 to enter an original sub dictionary and cut the MP3 file. At this time, the display screen 18 of the MP3 player 10 displays or brightens the editing indication 19 so that the users can make sure the editing procedure is performed.

Step S28: When the editing procedure is completed, disabling editing indication the display screen 18 of the MP3 player 10. The users can press control key 16 to leave the original sub-dictionary, to move to a destination sub-dictionary and to paste the MP3 file in the sub-dictionary so as to complete the editing procedure. When the editing procedure is finished, the display screen 18 of the MP3 player 10 disappears or darkens the editing indication, thus, the users will not be confused if executing another editing procedure.

Step S30 : Ending.

Due to the restriction of the display screen 18 of the MP3 player 10, the display screen 18 only displays required messages. However, when the users execute an editing procedure, there will be no indication or message of the current editing status, which will cause the users trouble in editing procedure. Applying the method of editing indication according to the invention, it is able to avoid the problem the users have to face in editing.

Other embodiments of the present invention will be apparent to those skilled in the art from consideration of the specification and practice of the present invention disclosed herein. It is intended that the specification and examples be considered as exemplary only, with a true scope and spirit of the present invention being indicated by the following claims.

What is claimed is:

1. A method of editing indication for a portable electronic device, comprising:
(A) selecting an electrical file;
(B) determining whether or not to execute an editing procedure on the electronic device;
(C) enabling the editing indication on a display screen of the portable electronic device; and
(D) disabling the editing indication the display screen of the portable electronic device when the editing procedure is completed.

2. The method of editing indication for a portable electronic device as claimed in claim 1, wherein the portable electronic device is a music player.

3. The method of editing indication for a portable electronic device as claimed in claim 1, wherein the portable electronic device is an MP3 player.

4. The method of editing indication for a portable electronic device as claimed in claim 1, wherein the portable electronic device is a WMA player.

5. The method of editing indication for a portable electronic device as claimed in claim 1, wherein the portable electronic device is an RM player.

6. The method of editing indication for a portable electronic device as claimed in claim 1, wherein the portable electronic device is a MIDI player.

7. The method of editing indication for a portable electronic device as claimed in claim 1, wherein the electronic file is in music format.

8. The method of editing indication for a portable electronic device as claimed in claim 1, wherein the electronic file is in an MP3 music format.

9. The method of editing indication for a portable electronic device as claimed in claim 1, wherein the electronic file is in a WMA music format.

10. The method of editing indication for a portable electronic device as claimed in claim 1, wherein the electronic file is in an RM music format.

11. The method of editing indication for a portable electronic device as claimed in claim 1, wherein the electronic file is in a MIDI music format.

12. The method of editing indication for a portable electronic device as claimed in claim 1, wherein the portable electronic device is a multimedia player.

13. The method of editing indication for a portable electronic device as claimed in claim 1, wherein the portable electronic device is an MPEG player.

14. The method of editing indication for a portable electronic device as claimed in claim 1, wherein the portable electronic device is an MPEG 2 player.

15. The method of editing indication for a portable electronic device as claimed in claim 1, wherein the portable electronic device is a DAT player.

16. The method of editing indication for a portable electronic device as claimed in claim 1, wherein the portable electronic device is an AVI player.

17. The method of editing indication for a portable electronic device as claimed in claim 1, wherein the portable electronic device is an MPEG 4 player.

18. The method of editing indication for a portable electronic device as claimed in claim 1, wherein the portable electronic device is a personal digital assistant.
